(19) United States
(12) Patent Application Publication
(10) Pub. No.: US 2008/0307211 A1
(43) Pub. Date: Dec. 11, 2008

(54) METHOD AND APPARATUS FOR DYNAMIC CONFIGURATION OF AN ON-DEMAND OPERATING ENVIRONMENT

(76) Inventors: Lianjun An, Yorktown Heights, NY (US); Shyh-Kwei Chen, Chappaqua, NY (US); Jun-Jang Jeng, Armonk, NJ (US)

Correspondence Address: Whitham, Curtis, Christofferson & Cook, P.C.;Suite 340, 11491 Sunset Hill Road, Reston, VA, 20190, US

(21) Appl. No.: 11/761,138

(22) Filed: Jun. 11, 2007

(51) Int. Cl. G06F 9/22

(52) U.S. Cl. 713/1

(57) ABSTRACT

A method is provided for systematic and dynamic configuration of an On Demand Operating Environment (ODOE) and the business solutions built upon the ODOE. The method provides a configuration specification that defines an On Demand Configuration Language (ODCL). An editor enables the business user to describe the consistency constraints applicable to the business in terms of the ODCL. This language is then used to transform the high-level business consistency constraints to low-level configuration parameters applicable to services and hosted business solutions in the ODOE. These services and hosted business solutions are organized into a plurality of layers to facilitate development of the configuration specification and better enable controls over consistent implementation of configuration changes. A two phase configuration commitment protocol is provided to ensure the consistent implementation of interdependent configuration parameters applicable to the services and hosted business solutions within the ODOE.

### BACKGROUND OF THE INVENTION

1. Field of the Invention

The present invention generally relates to on-demand operating environments and, in particular, to adapting the configuration of these environments to changing business conditions.

2. Background Description

The modern business environment requires computers and computing services, but competitive pressures place a premium on adapting these services to changing conditions. Investments in these services are placing an increasing drain on enterprises whose primary business is not computers or computing services. Consequently, a market has developed for providing computing services to such enterprises “on demand”, that is, on a pay-as-you-go basis, without an investment burden and without the risks of maintaining that investment.

In order to serve this developing market, an On Demand Operating Environment (ODOE) must be constructed and configured. Furthermore, ODOE will become more complex as it is being adopted to serve as a viable platform for developing and deploying business solutions for enterprises. Customers will expect not only to be provisioned with on-demand services; they will also expect to be able to change the behavior of their solution in an on-demand fashion.

That is, the same enterprise that will be attracted to having their computing services be provided by someone outside the enterprise will, nonetheless, want those services to be adaptable and responsive to the changing business needs of the enterprise. However, this adaptability and responsiveness was often the primary reason for the enterprise to provide its own computing services. It is not at all clear in the prior art how the enterprise can have it both ways: outsource the provisioning of computing services, and at the same time retain a sufficiently tight coupling to the adaptive levers of these services so that the services efficiently respond to the changing business needs of the enterprise as viewed by the business managers who have outsourced computing services. Therefore, an important aspect of a resolution of these problems with the prior art will be an ability to dynamically configure business solutions that are built on ODOE.

Current approaches do not provide a satisfactory solution for this requirement. The configuration of business solutions within an enterprise refers to the setting of parameters for each component in a business solution, from high level application programs to low level communication and hardware services. A business solution may be understood as a multilayered system of interrelated components. Because the components are interrelated the configuration of one component must take account of the configuration of other components which are related. Changes to a parameter setting for one component may affect or depend upon parameter settings for other components. The prior art still takes a traditional, labor-intensive and static approach to configuration of these interrelated components of a business solution. Variable parameters are iteratively adjusted and tested until satisfactory performance is obtained. By “static” is meant that the configuration stays the same until there comes a time when it must be redone in the same labor intensive fashion.

This type of configuration approach is error prone and can easily introduce inconsistencies among different solutions using different configuration properties. Current implementations of this approach tend to be low-level and dependent upon administrators to bridge the semantic gaps between new business requirements and a system-level configuration. Business users (e.g. managers of the business where computing services have been outsourced) are not able to inject their changes into ODOE and sense the effects of these changes in a reasonably prompt manner.

Business users need responsiveness with a short turn around time, if not real time, and current approaches to the need for prompt changes in the configuration of business solutions are insufficiently responsive. Current configuration mechanisms, e.g., such as Web Application Services (WAS) Websphere Common Configuration Model (WCCM), do not support consistency checking and a two-phase commitment protocol to guarantee the soundness and completeness of configuration activities towards ODOE. What is needed is a comprehensive approach to customizing business solutions that are built upon an ODOE. What is needed is an improved and simplified user experience for deploying, configuring and customizing business centric solutions on ODOE.

### SUMMARY OF THE INVENTION

It is therefore an object of the present invention to provide a comprehensive approach to customizing business solutions that are built upon an ODOE.

Another object of the invention is an improved and simplified user experience for deploying, configuring and customizing business centric solutions on ODOE.

It is also an object of the invention ensure that the results of changes in the configuration can be sensed by business users promptly, if not in real time.

Yet another object of the invention is to provide a systematic method of configuring ODOE and business solutions built upon it in a dynamic fashion.

A further object of the invention is to provision a business-level configuration specification named On Demand Configuration Language (ODCL).

Yet another object of the invention is to capture business consistency constraints in ODCL and transform these into low-level configuration constraints or parameters, which can be realized via either configuration rules or code generation.

Another object of the invention is to provide a two phase configuration commitment protocol to ensure the consistency of configuration properties or parameters within ODOE and hosted business solutions.

The invention provides a systematic method of dynamically configuring ODOE and the business solutions built upon it. The invention improves on the prior art by providing a method of transforming from high level service configurations (i.e. at the level familiar to the business user) down through the lowest implementation service levels without cracks or holes in the complete configuration. The dynamic aspect of this configuration method means that the system can be configured “on-the-fly”, without shutting down the system. The invention uses an On Demand Configuration Language (ODCL) to develop a business level configuration specification. This language allows the business user to specify requirements for the ODOE in terms of the business solutions needed for the business to be effective in the marketplace. Business consistency constraints are captured in ODCL, and these are then transformed to low-level configuration constraints or parameters, which can be realized through configuration rules or code generation. A two phase configuration commitment protocol is provided to ensure the consistency of configuration properties within ODOE and hosted business solutions.

One aspect of the invention is a method for dynamic configuration of an On Demand Operating Environment (ODOE) for a business by a number of steps. The first step is provisioning a configuration specification for the purpose of capturing business consistency constraints, and also for the purpose of using these consistency constraints to set configuration parameters downstream of the business consistency constraints as viewed by business users. In this manner configuration parameters are established for services provided to the business via the ODOE, which may also include any business solutions (e.g. implemented as software applications) that may be hosted by the ODOE.

The second step is capturing from managers of the business consistency constraints of the business in a language defined by the configuration specification. In a third step, the configuration specification is used to transform the consistency constraints into configuration parameters for the downstream services and hosted business solutions, where the configuration parameters for at least one of the services or business solutions is dependent upon configuration parameters for another of the services or business solutions. A fourth step is controlling implementation of these configuration parameters to ensure consistency among those that are dependent.

Another aspect of the invention is using the configuration language to synthesize configuration agents for configuring the downstream services and business solutions in accordance with the business consistency constraints, and controlling operation of these configuration agents to execute a coordinated configuration of the downstream services and business solutions in accordance with the consistency constraints.

A further aspect of the invention is monitoring performance indicators that measure operation of the services and the business solutions in relation to the consistency constraints, detecting changes in these performance indicators, and using the detected changes to trigger a repetition of the coordinated configuration. This is how the configuration is maintained dynamically as business conditions change within a given set of consistency constraints, or when the business users change the consistency constraints. Because the configuration parameters for the downstream services and business solutions are interdependent, it is another aspect of the invention to execute the coordinated configuration using a two-phase commitment protocol controlled by a configuration manager. A two-phase commitment protocol, as known in the prior art, is a distributed algorithm that lets all nodes in a distributed system agree to commit a transaction. A coordinator sends a “query to commit” message to all nodes, each of which executes the transaction, but without releasing blocked resources. This permits each node to undo the transaction. The coordinator waits for a response from each node, indicating that the transaction succeeded or failed. In the second phase, the coordinator sends a “commit” message if the response from all nodes is that the transaction succeeded, otherwise sending an “abort” message. Each node then releases any blocked resources upon receiving a “commit” message, and backs out of the transaction before releasing blocked resources if the received message from the coordinator is “abort”. In the present invention, the plurality of configuration agents and configuration points, where the configuration parameters applied by one configuration agent depend upon another, provide an analogy to distributed nodes.

Yet another aspect of the invention is that the downstream services and business solutions are organized into a plurality of layers. This is done to facilitate provisioning of the configuration specification and also to facilitate controls that enable consistent implementation the interdependent configuration parameters. In a further aspect of the invention, the performance indicators whose changes are monitored and used to trigger re-configurations dynamically are generated by algorithms, which in turn operate upon correlations generated when rules expressing the business consistency constraints are applied to an event stream. The events in this stream can be events observed by business users and placed in the stream of events by data entry, events output by learning algorithms monitoring oral or written communications of business users, and events reported by monitors within a runtime ODOE.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic representation of a preferred implementation of the invention.

FIG. 2 is a schematic representation of how the invention operates to configure a particular component of ODOE.

FIG. 3 is a schematic diagram showing the generation and deployment of configuration agents.

FIGS. 4A and 4B describe a metamodel skeleton for an On Demand Configuration Language, carried through to an action policy schema.

FIG. 5 is a schematic diagram showing how rules and a correlation engine are applied to an event stream to generate key performance indicator (KPI) trees.

### DETAILED DESCRIPTION OF A PREFERRED EMBODIMENT OF THE INVENTION

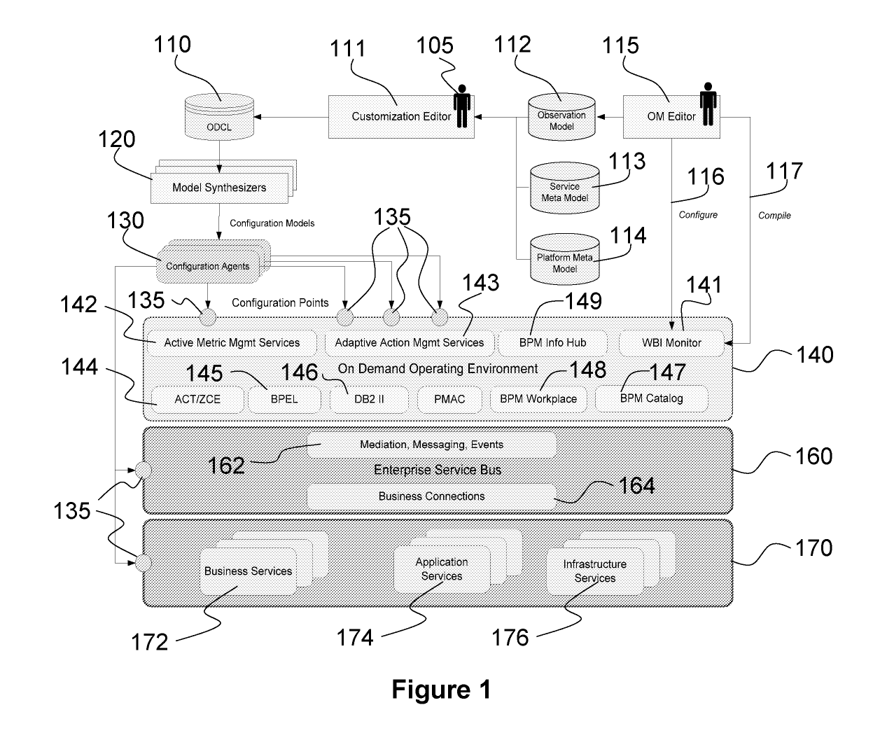

Referring now to the drawings, and more particularly to FIG. 1, there is shown a stylized schematic of the invention. The business solution components upon which the invention operates are shown in layers 140, 160 and 170. These are exemplary only, and in practice there may be many more levels than those shown here for the purpose of clarity in describing the invention. The On Demand Operating Environment (ODOE) 140 may include, for example, IBM products (Websphere Business Integration (WBI) Monitor 141, DB2 II 146, Business Process Management (BPM) Workplace 148) and system level services (Active Metric Management Services 142, Adaptive Action Management Services 143, an Active Correlation Technology (ACT) platform using a Zurich Correlation Engine (ZCE) 144, a Business Process Execution Language (BPEL) platform 145, BPM Catalog 147 and BPM Information Hub 149). All of them are target services and subsystems to be configured.

Enterprise Service Bus 160 is the communication channel among services in the ODOE 140, and is a configuration target. Mediation, Messaging, Events 162 represent the mechanism enabling communication among services in the ODOE 140. They are configuration targets as well. Business Connections 163 represent business level connection interfaces (as opposed to system-level connection interfaces) and are configuration targets. Layer 170 provides customized services for customers, which are also target services to be configured by the invention. Business Services 172 (e.g. YouTube, Bicycle Service, etc.), Application Services 173 (e.g. Email Services, Version Control, etc.), and Infrastructure Services 174 (e.g. Network Services, Storage Services, etc.) are also target services to be configured.

These layers are illustrative only, and in practice there may be many more layers, the layers being defined so as to provide a robust organization of the interrelated components of the business solution. The structure of these layers is, first of all, adapted to provide a transformation from high level services and corresponding configuration parameters down to the lowest IT implementation levels in a manner that is consistent and complete. By breaking this transformation down into a sequence of stages at successive layers, a complex and difficult process is made manageable and cracks and holes are minimized in the transformation of high level parameters into low level configuration parameters. Further, the collection of layers is not only adapted to show interrelationships between and among component services but is also structured to remain adapted to these interrelationships over a wide range of changes in component parameters as the configuration is dynamically adjusted.

On Demand Configuration Language (ODCL) 110 is a model repository that contains configuration models required for configuring target systems and services. It is customized by a customization editor 111 to serve the needs of a particular business. It is here that the perspective of the business user 105 is addressed. The business user 105 typically is conversant with the business operations that make up the business processes that produce the products and services of the business, but is not knowledgeable about operation of the systems and components (arrayed in exemplar layers 140, 160, and 170) upon which those business operations and processes rely.

It is therefore necessary to provide a mechanism for translating user requirements and configuration decisions with respect to the business operations and processes about which the user is knowledgeable into corresponding requirements of the systems and components about which the business user 105 is not knowledgeable. This is the function of the customization editor 111, a configuration editor which uses an observation model (OM) 112, a service meta-model 113 and a platform meta-model 114 to define business level configuration models for ODCL 110. Observation model 112 describes the monitored attributes of target systems and services; service meta model 113 describes the interfaces and semantics of target services; and platform meta model 114 describes the interfaces and semantics of target systems. The observation model 112 is itself subject to revision by OM editor 115, which is used by the system administrator to define observation models. OM editor 115 also configures 116 and compiles 117 observation model data for use by a monitor 141, such as IBM's WBI monitor, that monitors attributes of ODOE processes.

The ODCL 110 is used to develop model synthesizers 120, which take configuration models at the business level (generated by business user 105 using customization editor 111) and convert them into system level configuration models. Each configuration agent 130 takes a system configuration model and applies it to target systems and services via configuration points 135, which serve as a “façade” for the target systems and services to be configured. Configuration agents 130 also coordinate all configuration tasks including the timing of configuration of the physical services and systems.

From the perspective provided by the invention, the business operations and processes familiar to the business user 105 are described in terms of business services which can be knowledgeably configured by the business user 105. These business services are described within ODCL 110, which also describes the relationships between and among these business services and the ODOE services which support these business services. These ODOE support services are particular to the business solution provided by the business, and would be included in a top layer (e.g. ODOE layer 140).

For example, if a business manufactures bicycles the business services familiar to the business user 105 would include, for example, a bicycle parts ordering service, a bicycle parts assembly service, and a bicycle product delivery service, each of which might be operated or controlled by employees of the business. These services would be configured in terms of parameters familiar to, and determined by, the business user 105, such as the number of bicycles of a particular model to be produced per month, the quality and cost ranges of parts on a bicycle parts list, and the assembly time and order of assembly for the various parts. These services may in turn be supported by ODOE services, such as a database service for tracking bicycle orders and fulfillment, an Internet ordering service for procurement of parts, and an assembly monitoring service for tracking the time required to assemble the various parts. If automated equipment is used to assemble the bicycles, ODOE services might include a robotic maintenance service for monitoring and managing performance of the equipment. In turn, these ODOE services will require services from other levels of the arrayed component services, such as a messaging service 162 to carry messages from sensors at a bicycle assembly line over an enterprise service bus 160 to support the assembly monitoring service. Each of these support services will have their own configurable parameters, and the ODCL 110 will use these parameters to describe the relationships between these services.

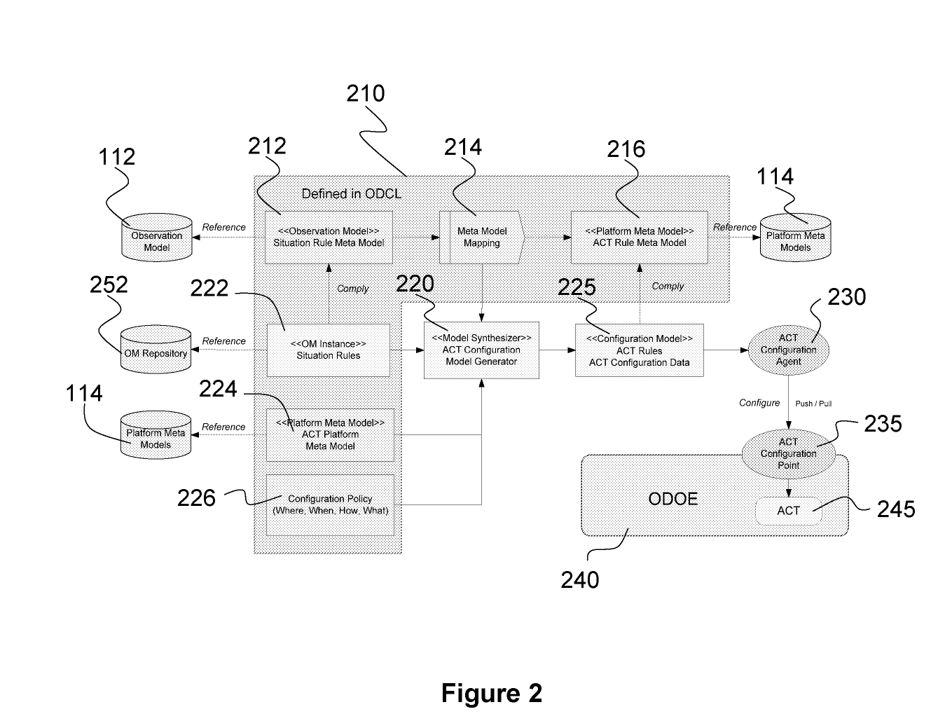

Now turning to FIG. 2, configuration policy 226 must be turned into rules which can be executed by a configuration agent 230 at a configuration point 235. For the purposes of illustration IBM's ACT tool is shown as the target for the configuration method shown in FIG. 2, but “ACT” could be replaced by any service to be configured. Configuration policy 226 describes at a high level what is to be configured, how it is to be configured, when it is to be configured and where it is to be configured. For example, in the bicycle business described above the manufacturing plant may be in city A, the servers that support the business may be located in city B, and a communications link is used to connect the bicycle business plant to its servers. The servers in City B and the communications link connecting City A and City B are among those low level services that must be included in the configuration structure of levels beginning at top level of the services that comprise the bicycle business. The policy 226 may target a particular time window (say, March of the current year) for the configuration, and may indicate how the configuration is to be done by specifying a particular configuration tool (e.g. Tivoli by IBM).

FIG. 2 will now be used to describe in greater detail how the invention operates to transform configuration policy 226 so as to develop configuration agents (e.g. 235), using for illustrative purposes only ACT 245 as the configuration target. The elements of the process within the ODCL are shown inside the area 210. Although a plurality of model synthesizers 120, configuration agents 130, and configuration agents 135 are shown in FIG. 1, only an exemplar instance (model synthesizer 220, configuration agent 230, and configuration point 235) is shown in FIG. 2. Further, the example is for a particular component at a particular level, the rules engine (e.g. ACT 245) within ODOE level 240, but it will readily be appreciated that other components in other levels of the configuration structure would have their own configuration models and configuration agents, all consistent with the policies and rules defined in the ODCL 210.

It should also be noted that FIG. 2 therefore also applies dynamically, that is, where a change is to be made in the configuration the “what” portion of configuration policy 226 will address those aspects of the high level configuration parameters that are to be changed and the method of the invention will ensure that these changes flow through the configuration structure created by the invention in a seamless fashion without halting the system being reconfigured.

Observation model situation rule meta model 212 defines what is to be monitored and the corresponding metrics for monitoring, drawing upon observation models 112. It is fed by situation rules 222, which provide sequencing rules for the order in which components are configured, so that there are no surprises. Situation rules 222 in turn draws upon a repository of observation model instances 252, that is, monitoring data, so that rule meta model 212 is in compliance with the observed monitoring data. Also, the metrics used in situation rules 222 determine when control of the configuration process is to be moved from one configuration point 135 to another.

Situation rule meta model 212 feeds meta model mapping module 214 that describes the configuration mechanism and maps the sequence control rules into the platform meta model 216 of the configuration target (here, the ACT Rule Meta Model). The meta model mapping module 214 also feeds a particular model synthesizer 220 which generates a configuration model 225 for a particular component. Model synthesizer 220 is in turn fed by information from configuration policy 226 and the platform meta model 224 pertaining to the particular component (e.g. IBM's ACT rules engine, as shown) being targeted for configuration. The platform meta model 224 draws upon platform meta models 114, which describe the configuration mechanism and contains detailed information about the platform that the ODOE is operating on, such as what kind of networks and databases are being used. Rules and configuration data for the particular component are generated by the configuration model 225, which produces a configuration agent 230 which actually configures (at configuration point 235) the particular target configuration component at a level of the configuration structure (e.g. ACT 245 within ODOE 240). Note that the configuration model 225 is checked for compliance against the sequence control rules of platform meta model 216. Note also that the configuration level (e.g. ODOE 240) must be instrumented to be configurable via configuration point 235.

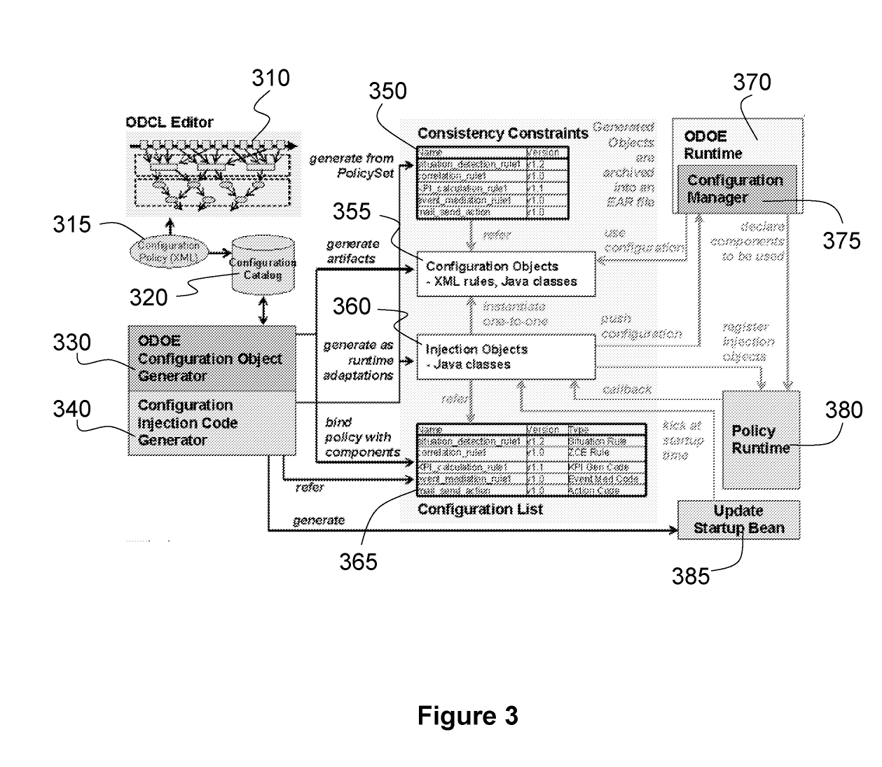

The configuration agents (130 in FIG. 1, 230 in FIG. 2) are generated as shown in FIG. 3. The process originates at a high level with the configuration policy 315 of the user (105 in FIG. 1) customized at ODCL Editor 310 (111 in FIG. 1) producing a configuration catalog 320 used by ODOE configuration objection generator 330 to generate configuration objects 355 and bind policy with components shown on configuration list 365. Configuration injection code generator 340 generates consistency constraints 350 from configuration policy 315. Consistency constraints 350 define rule sets that must be used together in order to preserve consistency. Configuration injection code 340 also generates injection objects 360 (such as Java classes) as runtime adaptations, refers to configuration list 365, and generates update startup bean 385. Note that consistency constraints 350 are typically expressed in terms of rule sets which must be used together, and refer to configuration objects 355. Injection objects 360 instantiate one-to-one with configuration objects 355, and reference configuration list 365. Note also that configuration list 365 shows actual configuration objects, that is, objects containing information actually used for configuring target entities.

The executable code generated by configuration injection code generator 340 is encapsulated in a configuration agent whose operation is directed by configuration manager 375, which is a part of ODOE runtime 370. Collectively, consistency constraints 350, configuration objects 355, injection objects 360 and configuration list 365 comprise the knowledge base of the encapsulated executable code which does the work of configuration. Configuration manager 375 is able to direct the sequencing of configuration agents via policy runtime 380 by being aware of consistency constraints 350. In the implementation shown, policy runtime 380 is included in the ACT component.

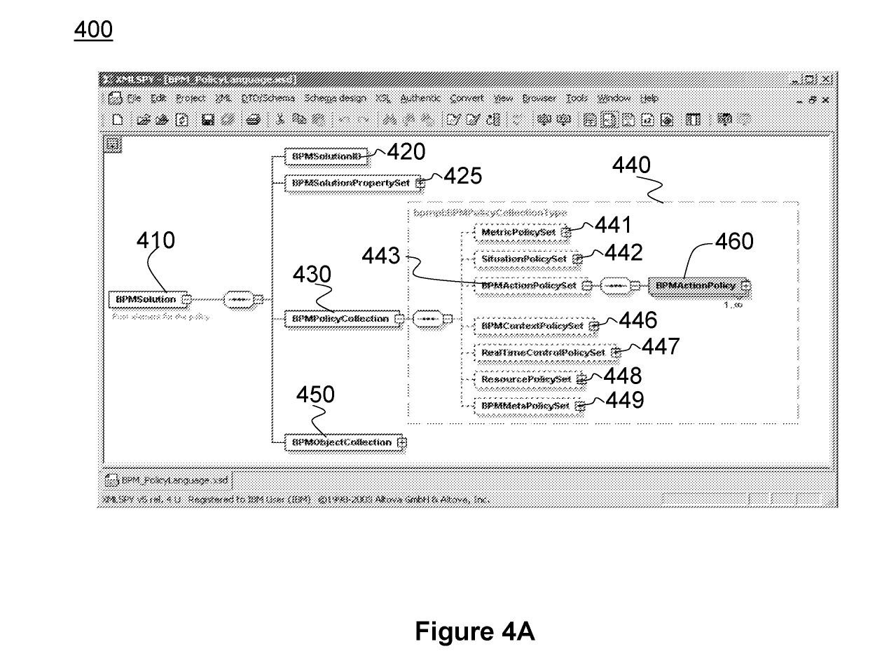

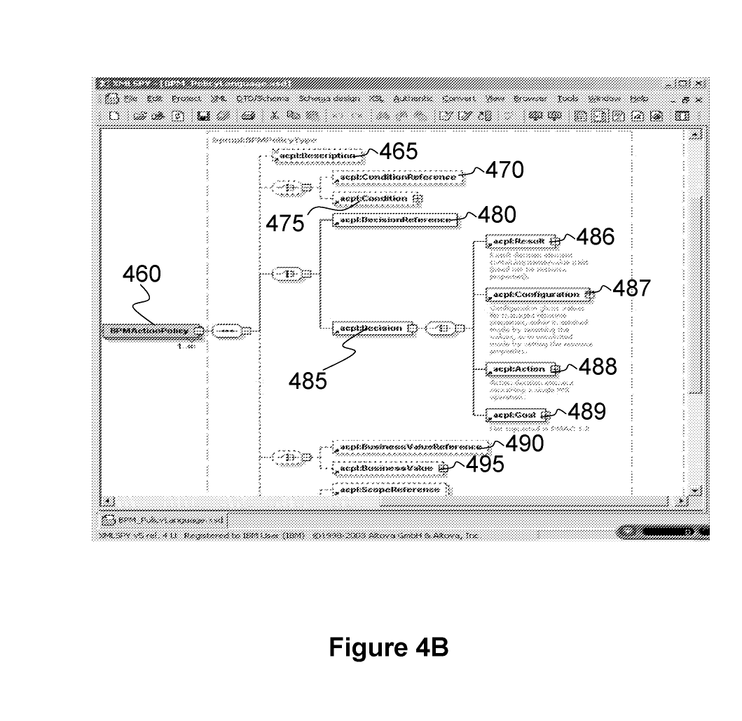

FIGS. 4A and 4B illustrate one implementation, in skeleton form, of the configuration language used in the ODCL (item 110 in FIG. 1). BPMSolution 410 is the root element for a policy, having ID 420, PropertySet 425, PolicyCollection 430 and ObjectCollection 450. PolicyCollection 430 has further elements MetricPolicySet 441, SituationPolicySet 442, BPMActionPolicySet 446, RealTimeControlPolicySet 447, ResourcePolicySet 48 and BPMMetaPolicySet 449. BPMActionPolicySet is comprised of BPMActionPolicy 460 elements, which are further described in FIG. 4B in terms of autonomic computing policy language (acpl) terms: Description 465, ConditionReference 470, Condition 475, DecisionReference 480, Decision 485, BusinessValueReference 490 and BusinessValue 495, among other acpl terms. Decision element 485 is further composed of Result 486, Configuration 487, Action 488 and Goal 489.

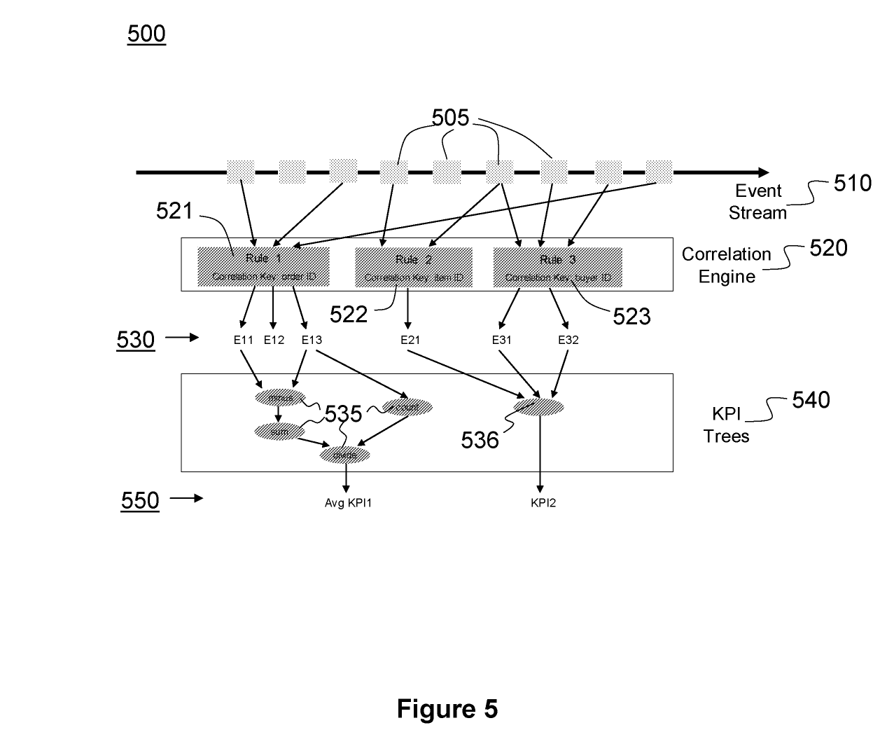

FIG. 5 is a schematic showing a mechanism for determining when the configuration manager (item 375 in FIG. 3) should trigger a dynamic reconfiguration of the system. Event stream 510 monitors events 505 relevant to the condition of the runtime ODOE. These events may reflect user contacts with customers and suppliers, placed on the event stream 510 by data entry or by communications passed through learning or recognition algorithms. Or they may be the result of monitors placed within the runtime ODOE. These events 505 are analyzed by a correlation engine 520 with reference to a set of rules (e.g. 521, 522 and 523), resulting in a set of derived events 530. These derived events (E11, E12, E13, etc.) are used in a set 540 of Key Performance Indicator (KPI) tree algorithms (e.g. 535, 536) that generate KPIs 550. Based on thresholds or ranges of these KPI values, the configuration manager triggers a dynamic reconfiguration of the ODOE. The scope of the reconfiguration will depend upon the triggering KPI values and the logic of the corresponding KPI trees. It should be noted that the logic of the triggering mechanism outlined in FIG. 5 is derived from the configuration policies established by the user, and updated by the user, using the customization editor (item 111 in FIG. 1, item 310 in FIG. 3).

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for dynamic configuration of an On Demand Operating Environment (ODOE) for a business, comprising:
provisioning a configuration specification for capturing business consistency constraints and for using said consistency constraints to set configuration parameters for services provided to the business via the ODOE;
capturing from managers of the business consistency constraints of the business in a language defined by said configuration specification;
using said configuration specification to transform said consistency constraints into configuration parameters for said services provided to the business via the ODOE, said configuration parameters for at least one of said services being dependent upon configuration parameters for another of said services; and
controlling implementation of said configuration parameters to ensure consistency among said dependent configuration parameters.

2. A method as in claim 1, further comprising:
using said configuration language to synthesize configuration agents for configuring said services in accordance with said business consistency constraints; and
controlling operation of said configuration agents to execute a coordinated configuration of said services in accordance with said consistency constraints.

3. A method as in claim 2, further comprising:
monitoring performance indicators that measure operation of said services in relation to said consistency constraints;
detecting changes in said performance indicators; and
using said detected changes to trigger a repetition of said coordinated configuration.

4. A method as in claim 2, wherein said coordinated configuration is executed using a two-phase commitment protocol controlled by a configuration manager.

5. A method as in claim 1, wherein the configuration parameters are realized by configuration rules or code generation.

6. A method as in claim 1, wherein the business-level configuration specification is an On Demand Configuration Language (ODCL) adapted to ODOE.

7. A method as in claim 1, wherein said services include business solutions hosted by the ODOE and are organized into a plurality of layers to facilitate said provisioning of said configuration specification and also to facilitate said controlling implementation of said configuration parameters to ensure consistency.

8. A method as in claim 3, wherein said performance indicators are responsive to a stream of events, wherein rules expressing said consistency constraints are applied to said stream of events to generate correlations, and wherein algorithms operate upon the correlations to generate said performance indicators.

9. A method as in claim 8, wherein events in said stream of events comprise one or more of: events observed by business users and placed in said stream of events by data entry, events output by learning algorithms monitoring oral or written communications of business users, and events reported by monitors within a runtime ODOE.

10. A system for dynamic configuration of an On Demand Operating Environment (ODOE) for a business, comprising:
means for provisioning a configuration specification for capturing business consistency constraints and for using said consistency constraints to set configuration parameters for services provided to the business via the ODOE;
means for capturing from managers of the business consistency constraints of the business in a language defined by said configuration specification;
means for using said configuration specification to transform said consistency constraints into configuration parameters for said services provided to the business via the ODOE, said configuration parameters for at least one of said services is dependent upon configuration parameters for another of said services; and
means for controlling implementation of said configuration parameters to ensure consistency among said dependent configuration parameters.

11. A system as in claim 10, further comprising:
means for using said configuration language to synthesize configuration agents for configuring said services in accordance with said business consistency constraints; and
means for controlling operation of said configuration agents to execute a coordinated configuration of said services in accordance with said consistency constraints.

12. A system as in claim 11, further comprising:
means for monitoring performance indicators that measure operation of said services in relation to said consistency constraints;
means for detecting changes in said performance indicators; and
means for using said detected changes to trigger a repetition of said coordinated configuration.

13. A system as in claim 11, wherein said coordinated configuration is executed using a two-phase commitment protocol controlled by a configuration manager.

14. A system as in claim 10, wherein the configuration parameters are realized by configuration rules or code generation.

15. A system as in claim 10, wherein the business-level configuration specification is an On Demand Configuration Language (ODCL) adapted to ODOE.

16. A system as in claim 10, wherein said services include business solutions hosted by the ODOE and are organized into a plurality of layers to facilitate said provisioning of said configuration specification and also to facilitate said controlling implementation of said configuration parameters to ensure consistency.

17. A system as in claim 12, wherein said performance indicators are responsive to a stream of events, wherein rules expressing said consistency constraints are applied to said stream of events to generate correlations, and wherein algorithms operate upon the correlations to generate said performance indicators.

18. A system as in claim 17, wherein events in said stream of events comprise one or more of: events observed by business users and placed in said stream of events by data entry, events output by learning algorithms monitoring oral or written communications of business users, and events reported by monitors within a runtime ODOE.

19. A computer implemented method for dynamic configuration of an On Demand Operating Environment (ODOE) for a business, comprising:
first computer code for provisioning a configuration specification for capturing business consistency constraints and for using said consistency constraints to set configuration parameters for services provided to the business via the ODOE and for business solutions hosted by the ODOE;
second computer code for capturing from managers of the business consistency constraints of the business in a language defined by said configuration specification;
third computer code for using said configuration specification to transform said consistency constraints into configuration parameters for said services provided to the business via the ODOE and for said business solutions hosted by the ODOE, said configuration parameters for at least one of said services or said business solutions being dependent upon configuration parameters for another of said services or said business solutions; and
fourth computer code for controlling implementation of said configuration parameters to ensure consistency among said dependent configuration parameters.

20. A computer implemented method as in claim 19, further comprising:
fifth computer code for using said configuration language to synthesize configuration agents for configuring said services and business solutions in accordance with said business consistency constraints;
sixth computer code for controlling operation of said configuration agents to execute a coordinated configuration of said service components and said business solutions in accordance with said consistency constraints;
seventh computer code for monitoring performance indicators that measure operation of said services and said business solutions in relation to said consistency constraints;
eighth computer code for detecting changes in said performance indicators; and
ninth computer code for using said detected changes to trigger a repetition of said coordinated configuration,
wherein said coordinated configuration is executed using a two-phase commitment protocol controlled by a configuration manager.
